(19) United States
(12) Patent Application Publication
(10) Pub. No.: US 2022/0133088 A1
(43) Pub. Date: May 5, 2022

(54) MUTLI-PURPOSE GRILL SYSTEM

(71) Applicant: William Dwight Lewis, Clarksville, TN (US)

(72) Inventor: William Dwight Lewis, Clarksville, TN (US)

(21) Appl. No.: 17/086,359

(22) Filed: Oct. 31, 2020

(51) Int. Cl. A47J 37/07

(52) U.S. Cl. CPC A47J 37/0763; A47J 37/0718; A47J 37/0786

(57) ABSTRACT

A multi-purpose grill is described. The grill may include a housing comprising at least one sidewall defining a housing interior. The at least one sidewall may include a firebox door and a firebox opening leading to the housing interior. The grill may also include a pan that may be located in the housing interior, a cooking grate that may be located above the pan, and a removable lid that may be located above the cooking grate. The pan may sit on one or more removable rods.

### BACKGROUND

### Technical Field

The present invention relates to barbeque grills and bonfires.

### Background of the Invention

Grills for cooking food are well-known. For example, in a basic charcoal grill, the grill may include a housing holding charcoal, a cooking grate located above the charcoal, and a removable lid. The grill may also include a host of other features such as a plurality of legs, temperature gauges and the like.

Bonfires are also well-known. In some cases, users merely stand or sit around a plurality of logs on fire. In other embodiments, wood may be burned in a barrel.

U.S. Pat. No. 5,836,298 teaches a portable outdoor fireplace with a fire screen assembly convertible into a cooking grill. The fireplace includes top and bottom cover members and a fire screen assembly containing multiple screens extending vertically there between. The firescreen assembly includes a plurality of supports that support a cooking grate near the entrance of the fireplace at different locations. However, the fireplace does not allow for multiple styles of cooking such as direct heat, indirect heat, or smoking.

U.S. Pat. No. 9,038,620 teaches a multi-sided, portable outdoor fireplace convertible to an open grill, a rotisserie assembly, and a smoker assembly. The fireplace includes a carriage assembly with a pair of rotatable wheels and at least one leg member; a base pan assembly for containing a solid fuel heat source affixed to the carriage assembly; and a removable screen assembly residing on top of the base pan assembly. However, the structure of this portable outdoor fireplace is complex and has many parts.

It would be advantageous to provide a portable, easy-to-use, multi-function grill that has uses in addition to cooking food, such as containing a bonfire.

### SUMMARY OF THE INVENTION

The present disclosure provides a multi-purpose grill as described herein.

### BRIEF DESCRIPTION OF THE DRAWINGS

FIG. 1 illustrates a side perspective view of a multi-purpose grill of one embodiment of the present invention.

FIG. 2 illustrates another side perspective view of the grill of FIG. 1.

FIG. 3 illustrates a side perspective view of the grill of FIG. 1 with the lid removed.

FIG. 4 illustrates a side, exploded perspective view of the grill of FIG. 1.

FIG. 5 illustrates a side elevation view of the grill of FIG. 1.

FIG. 6 illustrates a sectional view of the grill of FIG. 5 taken along line 6-6 of FIG. 5.

FIG. 7 illustrates a side perspective view of a multi-purpose grill of another embodiment of the present invention with the lid removed.

FIG. 8 illustrates a closeup sectional view of the circled area labelled 8 in FIG. 6.

### DETAILED DESCRIPTION

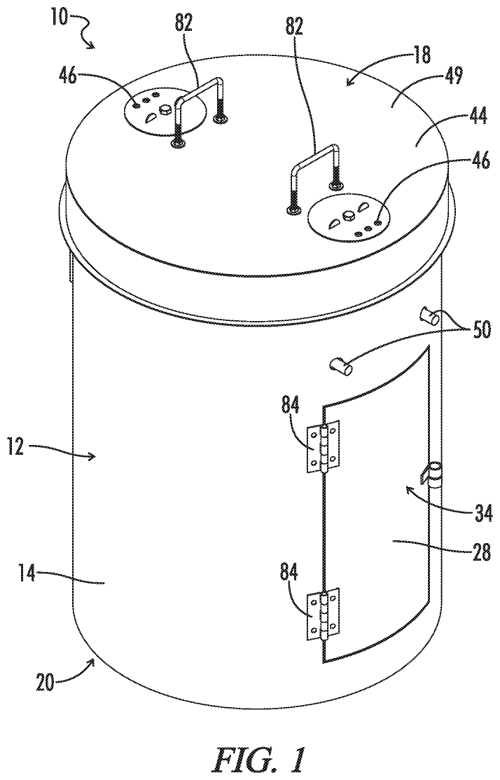

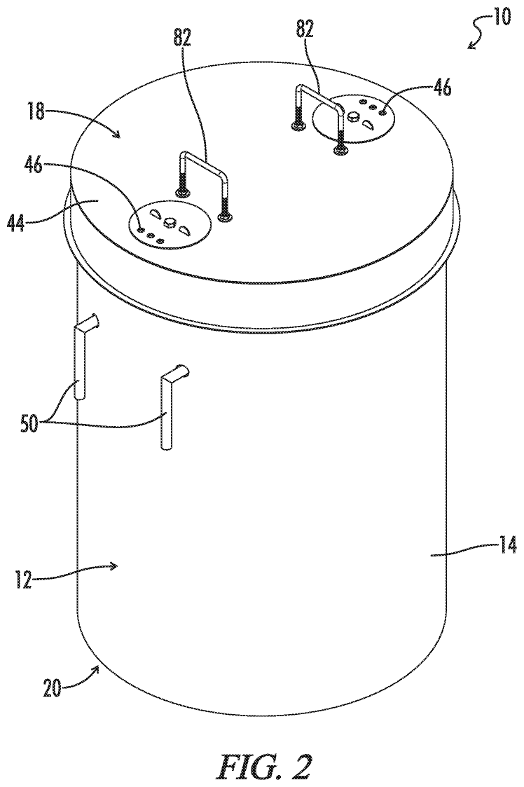

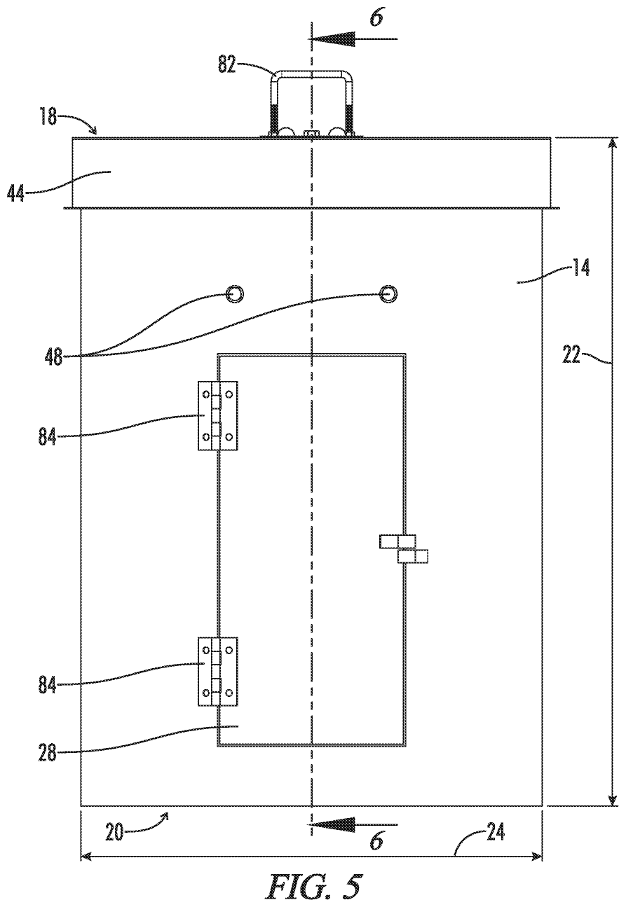

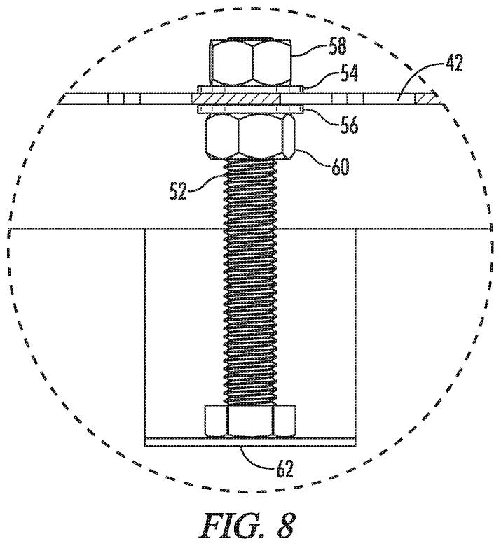

With reference to FIGS. 1-8, the present disclosure provides a multi-purpose grill designated by the numeral 10. In the drawings, not all reference numbers are included in each of the drawings for the sake of clarity. FIGS. 1-8 are drawn generally to scale, however, it will be appreciated that other dimensions are possible.

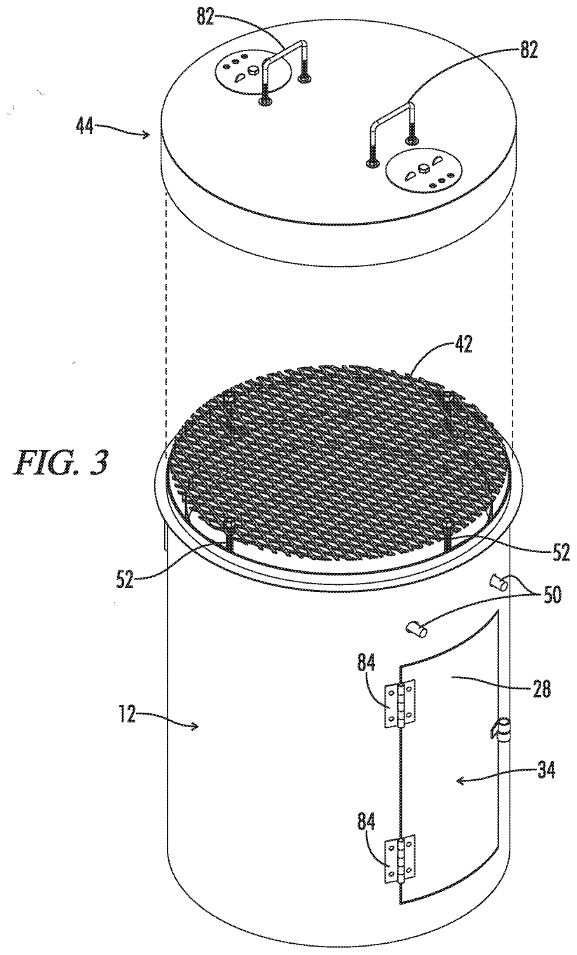

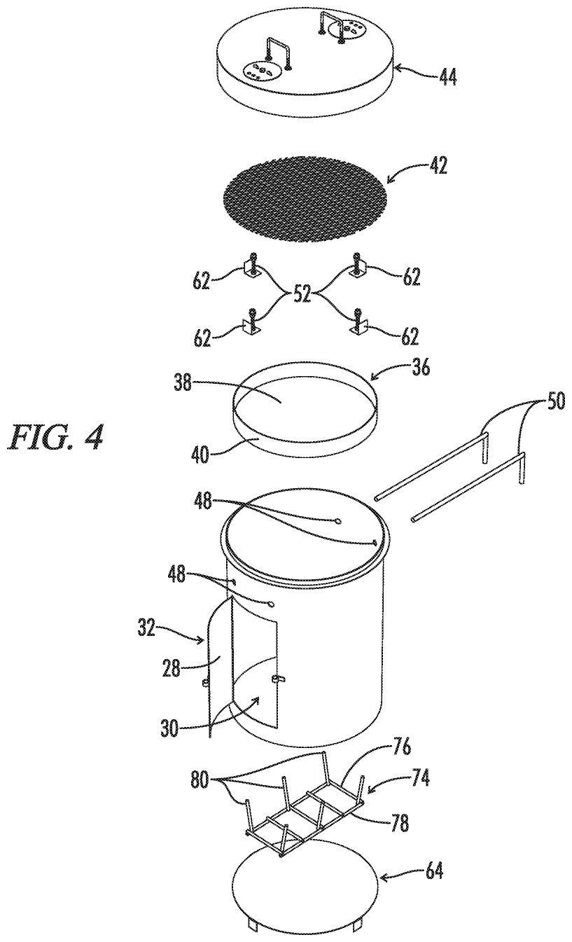

As shown in FIGS. 1-8, the multi-purpose grill 10 may include a housing 12 that may include at least one sidewall 14 that may define a housing interior 16, a housing top 18, a housing bottom 20, a housing height 22 extending from the housing top 18 to the housing bottom 20, a housing width 24 perpendicular to the housing height 22, and a housing length 26 perpendicular to the housing width 24 and housing height 22. As shown in FIGS. 1, 3-5 and 7, the at least one sidewall 14 may include a firebox door 28 and a firebox opening 30 leading to the housing interior 16. The firebox door 28 may be configured to pivot between an open position 32 in which the door does not cover the firebox opening 30 and a closed position 34 in which the firebox door 28 covers the firebox opening 30. The housing interior 16 may be at least partially hollow. As best seen in FIGS. 4, 6, and 7, the grill 10 may further include a pan 36 located in the housing interior 16. The pan 36 may include a pan bottom wall 38 located below the housing top 18 and at least one pan sidewall 40 extending upward from the pan bottom wall 38. As best seen in FIGS. 3-4 and 6, the grill 10 may also include a cooking grate 42 located above the pan 36. The cooking grate 42 may extend across the housing width 24 and the housing length 26. As best seen in FIGS. 1-6, the grill 10 may also include a removable lid 44 located above the cooking grate 42 that may form the housing top 18, the removable lid 44 optionally comprising at least one vent 46. The removable lid 44 may cover the cooking grate 42.

Optionally, to allow for the grill 10 to be used as a bonfire (as explained in greater detail below), the pan 36 is removable, and, as shown in FIGS. 1-7, the at least one sidewall 40 comprises at least two rod holes 48 located on opposite sides of the at least one sidewall 14, and the grill 10 further comprising a removable rod 50 removably extending through the at least two rod holes 48, the removable rod 50 located below and supporting the pan bottom wall 38. In the exemplary embodiment of FIGS. 1-7, the at least one sidewall 14 comprises four rod holes 48 and two rods 50, each of which removably extends through two rod holes 48. In the exemplary embodiment of FIGS. 1-7, the removable rod 50 is L-shaped with the shorter portion of the L pointing downwards. In the exemplary embodiment of FIGS. 1-7, the removable rod 50 extends across the housing length 26 or housing width 24. When it is said that the at least one sidewall 14 comprises at least two rod holes 48 located on opposite sides of the at least one sidewall 14, it will be understood that if the housing 12 is rectangular and thus includes four sidewalls 14, the rod holes will be located on two different sidewalls 14 (e.g., left and right or front and back). In such designs with more than one sidewalls 14, it will be understood that each sidewall 14 does not necessarily include a firebox opening 30.

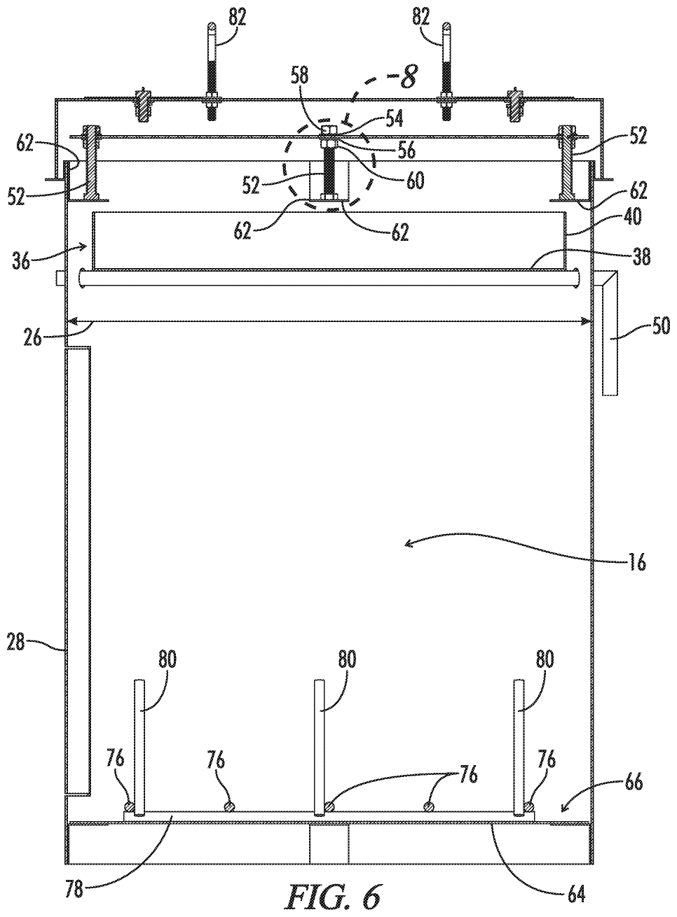

Optionally, the height of the cooking grate 42 is adjustable. For example, as best seen in the sectional view of FIG. 6, the grill 10 may further comprise at least two bolts 52 extending through the cooking grate 42, each bolt 52 comprising a top washer 54, a bottom washer 56 located below the top washer 54, a top nut 58 located above the top washer 54, and a bottom nut 60 located below the bottom washer 56. Optionally, the cooking grate 42 is located between the top washer 54 and the bottom washer 56 of each of the respective two bolts 52. Optionally, the at least two bolts 52 each rest on a ledge 62 located in the housing interior 16, the ledge 62 located below the bottom nut 60.

Optionally, as best seen in FIGS. 4 and 6, the housing 12 further comprises a bottom wall 64 forming a bottom 20 of the housing interior 16. Optionally, the bottom wall 64 is removable. The firebox opening 30 can be any suitable shape, including without limitation, circular, ovular, or rectangular. Optionally, the longest dimension of the firebox opening 30 is sized so that the bottom wall 64 may pass through the firebox opening 30. For example, for a rectangular firebox opening 30, the longest dimension would be the diagonal of the rectangle; for a circular firebox opening 30, the longest dimension would be the diameter of the circle; for an ovular firebox opening 30, the longest dimension would be the major axis. Relatedly, the bottom wall 64 also comprises a shortest dimension sized so that the bottom wall 64 may pass through the firebox opening 30. For example, for a circular bottom wall 64, the shortest dimension is the diameter; for a rectangular bottom wall 64, the shortest dimension is the length of the shortest side of the rectangle; for an ovular bottom wall 64, the shortest dimension is the minor axis of the oval. A person having ordinary skill would be able to determine the longest and shortest dimensions, for other shaped firebox openings 30 and bottom walls 64. Optionally, the longest dimension of the firebox opening 30 is greater than the shortest dimension of the bottom wall 64 to allow for removal of the bottom wall 64 through the firebox opening 30. Without being bound for any particular theory, addition or removal of the bottom wall 64 through the firebox opening 30 allows a user to increase or decrease the ventilation in the grill during cooking without lifting the housing 12, which may be hot.

The firebox opening 30 can be any suitable shape, including without limitation, circular, ovular, or rectangular.

Optionally, as best seen in FIG. 4, the housing interior 16 comprises a fire grate 74 configured to hold wood. The fire grate 74 may be positioned on the bottom wall 64. The fire grate 74 may include a first set of fire grate rods 76 lying in the plane formed by the housing width 24 and housing length 26, a second set of fire grate rods 78 lying in the plane formed by the housing width 24 and housing length 26 and perpendicular to the first set of fire grate rods 76, and a third set of fire grate rods 80 extending upwards out of the plane formed by the housing width 24 and housing length 26 and forming at least a thirty degree angle therewith. Optionally, like the removable bottom wall 64, the fire grate 74 is sized to be moved through the firebox opening 30 when the firebox door 28 is in the open position 32. Optionally, the fire grate 74 is holding wood.

Optionally, the housing 12 and the pan 36 are comprised of metal and are configured to withstand temperatures of at least 400 degrees Fahrenheit.

Optionally, as best seen in FIGS. 3-4, the housing 12 is cylindrical and the cooking grate 42 is circular.

Optionally, the at least one vent 46 is closeable.

Optionally, as best seen in FIGS. 1-6, the lid 44 comprises a substantially flat top 49, the substantially flat top 49 comprising a handle 82. Optionally, the lid 44 includes a temperature gauge 90 to inform the user of the temperature inside the grill 10. Such temperature gauges 90 are well-known in the art.

Optionally, the firebox opening comprises a longest dimension of at least 3 inches.

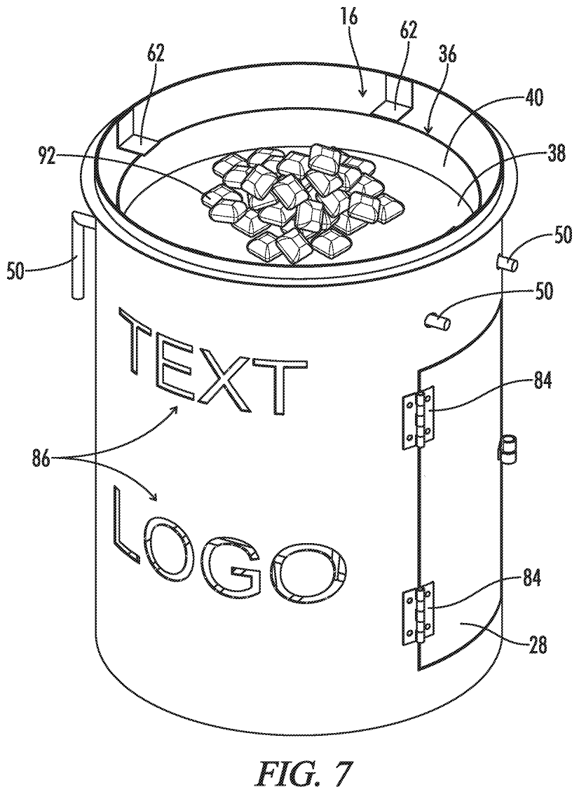

Optionally, as shown in FIG. 7, the pan 36 comprises charcoal 92 for cooking. Alternatively, the pan 36 may include other materials for cooking such as water or other liquid.

Optionally, as best seen in FIGS. 1, 3, 5 and 7, the grill 10 further includes a hinge 84 connected to the firebox door 28 and with a pivot axis extending generally parallel to the housing height 22, the hinge 84 configured to allow the door 28 to move between the open and closed positions 32,34.

Optionally, the grill 10 may be used as a bonfire. For example, a fire may be located in the housing interior 16. More particularly, as shown in FIG. 7, the sidewall 14 may include a first set of design holes 86 arranged in a pattern configured to allow a viewer on the outside of the housing 12 to view a fire in the housing interior 16. The first set of design holes 86 also may be configured to allow heat from the fire to escape the housing interior 16 and provide warmth to the viewer. The first set of design holes 86 may create text and/or graphics.

Optionally, the sidewall 14 further comprises a second set of design holes (not shown) arranged in a pattern and configured to allow a viewer on the outside of the housing 12 to view a fire in the housing interior 16. The second set of design holes 88 may be further configured to allow heat from the fire to escape the housing interior 16 and provide warmth to the viewer. The second set of design holes may be located on an opposite side of the at least one sidewall 14 as compared to the first set of design holes 86. As is the case with the rod holes 48, the first and second set of design holes 86 may be located in different sidewalls 14 (e.g., front and back or left and right) if the grill includes more than one sidewall 14.

Optionally, the first set of design holes 86 have a combined surface area of at least one square foot. Optionally, the first set of design holes 86 is located below the at least two rod holes 48. Optionally, except for the first and second set of design holes 86, the firebox opening 30 and the rod holes 48, the housing sidewall 14 is solid metal.

The grill 10 may be used in any suitable process, including but not limited to cooking food or creating a bonfire. For example, the grill 10 may be used in a method comprising: a) providing the grill 10; b) placing charcoal 92 in the pan 36 and igniting the charcoal 92; c) placing food on the cooking grate 42; and d) using heat provided by the charcoal 92 to cook the food. The grill may also be used for a method of smoking food wherein the method comprises: a) providing the grill 10; b) placing the pan 36 in the grill 10; c) adding water or other liquids such as juice to the pan 36; d) placing wood and/or charcoal 92 in the housing interior bottom 66 and igniting the wood and/or charcoal 92; e) placing food on the cooking grate 42; f) using heat and smoke provided by the wood and/or charcoal 92 to cook and flavor the food. Optionally, this method may be performed without the water or without the pan or water. Without being bound to any particular theory, using the pan with water, just the pan, or no pan creates different temperature profiles in the grill for different cooking styles.

Alternatively, the grill 10 may be used in a method of creating a bonfire, including: a) providing the grill 10; b) removing the cooking grate 42, pan 36 and lid 44; and c) igniting a fire in the housing interior 16. Optionally, the fire is located on the bottom wall 64. Optionally. the method further comprises, after step d), allowing heat from the fire to escape through the first set of design holes 86 (as well as viewing the fire through the first set of design holes 86).

### PART LIST

| | |
|---|---|
| Grill | 10 |
| Grill housing | 12 |
| Housing sidewall | 14 |
| Housing interior | 16 |
| Housing top | 18 |
| Housing bottom | 20 |
| Housing height | 22 |
| Housing width | 24 |
| Housing length | 26 |
| Firebox door | 28 |
| Firebox opening | 30 |
| Firebox door open position | 32 |
| Firebox door closed position | 34 |
| Pan | 36 |
| Pan bottom wall | 38 |
| Pan sidewall | 40 |
| Cooking grate | 42 |
| Removable lid | 44 |
| Removable lid vent | 46 |
| Rod holes | 48 |
| Removable lid substantially flat top | 49 |
| Removable rod | 50 |
| Bolts | 52 |
| Bolt top washer | 54 |
| Bolt bottom washer | 56 |
| Bolt top nut | 58 |
| Bolt bottom nut | 60 |
| Ledge | 62 |
| Housing removable bottom wall | 64 |
| Housing interior bottom | 66 |
| Fire grate | 74 |
| First set of fire grate rods | 76 |
| Second set of fire grate rods | 78 |
| Third set of fire grate rods | 80 |
| Grill lid handle | 82 |
| Hinge | 84 |
| First set of design holes | 86 |
| Temperature gauge | 90 |
| Charcoal | 92 |

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention. In addition, the steps of any method described herein may be performed in any suitable order and steps may be performed simultaneously if needed. Use of the singular embraces the plural.

Terms of degree such as “generally”, “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

1. A multi-purpose grill comprising:
a housing comprising at least one sidewall defining a housing interior, a housing top, a housing bottom, a housing height extending from the housing top to the housing bottom, a housing width perpendicular to the housing height, and a housing length perpendicular to the housing width and housing height, the at least one sidewall comprising a firebox door and a firebox opening leading to the housing interior, the firebox door configured to pivot between an open position in which the door does not cover the firebox opening and a closed position in which the firebox door covers the firebox opening, wherein the housing interior is at least partially hollow;
a pan located in the housing interior, the pan comprising a pan bottom wall located below the housing top and at least one pan sidewall extending upward from the pan bottom wall;
a cooking grate located above the pan, the cooking grate extending across the housing width and the housing length; and
a removable lid located above the cooking grate and forming the housing top, the removable lid comprising at least one vent,
wherein the pan is located entirely above the firebox door.

2. The grill of claim 1 wherein the pan is removable, wherein the at least one sidewall comprises at least two rod holes located on opposite sides of the at least one sidewall, and further wherein the grill further comprises a removable rod removably extending through the at least two rod holes, the removable rod located below and supporting the pan bottom wall.

3. The grill of claim 2 wherein the removable rod is L-shaped.

4. The grill of claim 2 wherein the removable rod extends across the housing length or housing width.

5. The grill of claim 1 wherein the grill further comprises at least two bolts extending through the cooking grate, each bolt comprising a top washer, a bottom washer located below the top washer, a top nut located above the top washer, and a bottom nut located below the bottom washer, and further wherein the cooking grate is located between the top washer and the bottom washer of each of the respective two bolts.

6. The grill of claim 5 wherein the at least two bolts each rest on a ledge located in the housing interior, the ledge located below the bottom nut.

7. The grill of claim 1 wherein the housing further comprises a removable bottom wall forming a bottom of the housing interior.

8. The grill of claim 7 wherein the firebox opening comprises a longest dimension, wherein the removable bottom wall comprises a shortest dimension, and further wherein the longest dimension of the firebox opening is greater than the removable bottom wall shortest dimension.

9. The grill of claim 1 wherein the housing further comprises a bottom wall forming a bottom of the housing interior; wherein the housing interior comprises a fire grate positioned on the bottom wall and configured to hold wood, the fire grate comprising a first set of fire grate rods lying in a plane formed by the housing width and housing length, a second set of fire grate rods lying in the plane formed by the housing width and housing length and perpendicular to the first set of fire grate rods, and a third set of fire grate rods extending upwards out of the plane formed by the first and second set of fire grate rods and forming at least a thirty degree angle therewith; and further wherein the fire grate is sized to be moved through the firebox opening when the firebox door is in the open position.

10. The grill of claim 9 wherein the fire grate is holding wood.

11. The grill of claim 1 wherein the housing and the pan are comprised of metal and are configured to withstand temperatures of at least 400 degrees Fahrenheit.

12. The grill of claim 1 wherein the housing is cylindrical and further wherein the cooking grate is circular.

13. The grill of claim 1 wherein the at least one vent is closeable.

14. The grill of claim 1 wherein the lid comprises a substantially flat top, the substantially flat top comprising a handle.

15. The grill of claim 1 wherein the firebox opening comprises a surface area of at least nine square inches.

16. The grill of claim 1 wherein the pan comprises charcoal.

17. The grill of claim 1 wherein a fire is located in the housing interior.

18. The grill of claim 1 further comprising a hinge connected to the firebox door and extending generally parallel to the housing height, the hinge configured to allow the door to move between the open and closed positions.

19. The grill of claim 1 wherein the at least one sidewall further comprises a first set of design holes arranged in a pattern configured to allow a viewer on the outside of the housing to view a fire in the housing interior, the first set of design holes further configured to allow heat from the fire to escape the housing interior and heat the viewer.

20. The grill of claim 19 wherein the at least one sidewall further comprises a second set of design holes arranged in a pattern and configured to allow a viewer on the outside of the housing to view a fire in the housing interior, the second set of design holes further configured to allow heat from the fire to escape the housing interior and heat the viewer, the second set of design holes located on an opposite side of the at least one sidewall as compared to the first set of design holes.

21. The grill of claim 20 wherein the first set of design holes have a combined surface area of at least one square foot.

22. The grill of claim 19, wherein the pan is removable, wherein the at least one sidewall comprises at least two rod holes located on opposite sides of the at least one sidewall, and further wherein the grill further comprises a removable rod removably extending through the at least two rod holes, the removable rod located below and supporting the pan bottom wall, and further wherein the first set of design holes is located below the at least two rod holes.

23. A method of using the grill comprising:
a) providing the grill of claim 1;
b) placing charcoal in the pan and igniting the charcoal;
c) placing food on the cooking grate; and
d) using heat provided by the charcoal to cook the food.

24. A method of using the grill comprising:
a) providing the grill of claim 1;
b) adding a liquid to the pan;
c) placing a fuel source below the pan and igniting the fuel source;
d) placing food on the cooking grate;
e) using heat and smoke provided by the fuel source to cook and flavor the food.

25. A method of using the grill comprising:
a) providing the grill of claim 1;
b) removing the cooking grate, pan and lid; and
c) igniting a fire in the housing interior.

26. The method of claim 25 wherein the housing further comprises a bottom wall forming a bottom of the housing interior and the fire is located on the bottom wall.

27. The method of claim 25, wherein the sidewall further comprises a first set of design holes arranged in a pattern configured to allow a viewer on the outside of the housing to view a fire in the housing interior, the first set of design holes further configured to allow heat to escape the housing interior and heat the viewer, and further wherein the method further comprises, after step c), allowing heat from the fire to escape through the first set of design holes.

28. The grill of claim 1 wherein the pan is removable, and further wherein the grill further comprises a rod located below, supporting the pan bottom wall and extending across the housing width or the housing length.
